(19) United States
(12) Patent Application Publication
(10) Pub. No.: US 2001/0016010 A1
(43) Pub. Date: Aug. 23, 2001

(54) Apparatus for receiving digital moving picture

(75) Inventor: Eung Tae Kim, Seoul (KR)

Correspondence Address: FLESHNER & KIM, P. O. Box 221200, Chantilly, VA, 20153-1200, US

(73) Assignee: LG Electronics Inc.

(21) Appl. No.: 09/769,421

(22) Filed: Jan. 26, 2001

(30) Foreign Application Priority Data
Jan. 27, 2000 (KR) 4018/2000
Jan. 27, 2000 (KR) 4019/2000

(51) Int. Cl. H04N 7/12

(52) U.S. Cl. 375/240.25; 375/240.17; 375/240.2; 375/240.21

(57) ABSTRACT

An apparatus for receiving digital motion pictures for down-conversion of interlaced scanning sequence in DTVs or application fields of digital picture meeting systems is disclosed, in which received DCT coded blocks are down-sampled as they are if the blocks are field DCT coded blocks, or converted to the field DCT coded blocks to carry out the down-sampling and stored in the memory for the motion picture if the blocks are frame DCT coded blocks, or the field DCT coded blocks and the frame DCT coded blocks are stored after down-conversion into pictures having fixed top field pixels for the motion prediction compensation, so that 75% memory reduction effect may be obtained by a video decoder having a down converter for the interlaced scanning sequence of the HD grade, and a screen of the SD grade with high screen quality may be obtained in the display devices for the various PIPs or the low resolution display.

### BACKGROUND OF THE INVENTION

1. Field of the Invention

The present invention relates to a digital TV system, and more particularly to a down conversion decoder to reduce an external memory of a MPEG-2 decoder.

2. Discussion of the Related Art

Recently, digital TV broadcasting has been gaining much attention. Accordingly, efforts are being made to compress and transmit video data to allow a clear and high definition screen on consumer TVs. An MPEG-2 is primarily used as an algorithm to compress the video signals. The MPEG-2 algorithm has allowed and prompted further research to transmit digital data of high definition through general broadcasting channels. Accordingly, a digital TV receiver requires a MPEG-2 video decoder for reconstruction of the compressed data to the original video data of high definition.

FIG. 1 is a block diagram of a MPEG decoding system in the related art. Referring to FIG. 1, a transport (TP) demultiplexer 101 selects a program signal from a plurality of programs included in one channel, and separates the selected signal packet into audio bit stream and video bit stream to respectively output the separated audio and video bit streams to an audio decoder 102 and a video decoder 104 to perform decoding operation. The audio and video bit streams are packetized elementary streams (PES).

At this time, the audio decoder 102 restores the input audio bit stream to an original signal using an MPEG algorithm or an audio coding (AC)-3 algorithm. A digital to analog converter (DAC) 103 converts the restored audio signal to an analog signal and outputs the converted signal to a speaker.

The video decoder 102 eliminates overheads, such as various header information and start codes, from the video bit stream and performs a variable length decoding (VLD) of pure data. The video decoder 102 also performs an inverse quantization, and an inverse discrete cosine transformation (IDCT) to restore pixel values of the original screen and to output the pixel values to a video display processor (VDP) 105. The VDP 105 converts the restored video signal in compliance with a display format and outputs the converted data to a display device.

FIG. 2 is a detailed diagram of the MPEG video decoder 104. The video bit stream separated by the transport demultiplexer 101 are input to a variable length decoder (VLD) 202 through a buffer 201. The VLD 202 performs variable length decoding of the video bit stream to divide it into a Motion Vector (MV), a quantization value, and a DCT coefficient. Thus, the VLD 202 outputs the MV to a motion compensator 206 and outputs the quantization value and the DCT coefficient to an Inverse Quantizer (IQ) 203. At this time, since the DCT coefficient is coded in a zig-zag scan method or an alternate scan method, it is inverse scanned by a raster scan method. The inverse scanned DCT coefficient is inverse quantized in accordance with a quantization value and then output to an IDCT unit 204. The IDCT unit 204 performs IDCT of the inverse quantized DCT coefficient in 8×8 block unit in compliance with an MPEG-2 video syntax and then outputs the resultant value to an adder 205.

Meanwhile, the MV output from the VLD 202 is output to the motion compensator 206, and the motion compensator 206 performs motion compensation for a current pixel value using the MV and a previous frame stored in a memory 208 to output the resultant value to the adder 205.

The adder 205 adds the IDCT value to the motion compensated value to restore a complete video which is a final pixel value, and then outputs the final pixel value to the VDP 209. The VDP 209 outputs data by rearranging the data in accordance with picture types and also outputs the data without additional processing.

In case of Intra-picture (I-picture), IQ/IDCT resultant value is directly stored in the memory 208. In case of a Predictive picture (P-picture) or Bi-directional picture (B-picture), the motion-compensated data are added to the IDCT resultant value by the adder 205 and then the resultant value is stored in the memory 208.

In other words, the video decoder system based on MPEG-2 uses an external memory 208, which comprises a buffer and two or more frame memories for temporarily storing a bit stream. Here, a dynamic RAM (DRAM) is usually used as the frame memory. In a video decoder, the role of the external memory 208 is mainly divided into the following categories: writing and reading data for video decoding; reading data required for motion compensation; and writing and reading of decoded data to be displayed. The data are exchanged under the control of a memory interface 207.

However, to decode a video data of MPEG-2 MP@HL, a large memory and a high speed data transmission are required. Also, a bit-buffer size of about 10 Mbits with maximum bit rate of about 80 Mbit/s is required to support the MP@HL mode within the standard MPEG-2. Accordingly, a MPEG-2 video decoder based on the conventional 16 Mbits of DRAM requires an external memory of about 96-128 Mbits. This means an escalation in the cost of the memory.

For competitiveness of the product cost as well as for an appeal to consumers, it is critical to retain a motion picture of high definition while reducing the price of the memory. Moreover, in view of the current trend of providing diverse kinds of on-screen display (OSD) and services, additional memories would probably be required in the future. For example, recent MPEG-2 video decompression system provides diverse services by decoding and simultaneously displaying multiple types of video signals. In such case, the system should be able to decode multiple video signals using a limited memory.

In consideration of the limits and costs of a memory as well as the bandwidth of a data bus, to view a high resolution video of an MPEG-2 MP@HL through a TV of SD grade having a low resolution screen or other monitors, an efficient memory reduction apparatus is required to minimize the loss of high definition video signals in a video decoding chip. That is, since a display device of the current HDTV is expensive and is not widely spread, it is necessary to display a video sequence of picture quality with high resolution HD grade at reduced resolution through a TV of an existing NTSC grade. At this time, it is necessary to allow viewers to view an HDTV signal without purchasing an expensive HDTV display device. As a result, several methods have been suggested for that purpose.

One memory reduction algorithm in the related art is mounted inside a video decoding chip and suggests an Adaptive Differential Pulse Coded Modulation (ADPCM) having a reduction rate of 50%. Another memory reduction algorithm in the related art which is mounted inside a video decoding chip eliminates spatial redundancy using a vector quantization (VQ) having a reduction rate of 75%. Moreover, a compressing manner utilizing a down conversion algorithm in a video decoding chip has been suggested.

However, in the above methods, since a compressed code is stored in a memory, it is difficult to directly display a video signal using the video display device. That is, a device for restoring the compressed code is additionally required. Also, in case of the ADPCM having a reduction rate of 75%, since loss of picture quality is very great, a result that is not suitable for the video decoder arises.

Meanwhile, as examples of the down conversion algorithm, there are a method for performing down-sampling in a spatial region with respect to horizontal and vertical directions and a method for performing filtering/down-sampling in a DCT frequency region.

For application the above down conversion methods to the MPEG-2 video system, a method for encoding an MPEG-2 video signal will be described.

Generally, an MPEG-2 decoder performs encoding by receiving a progressive sequence or an interlaced sequence. A row of an image obtained by progressive scanning is referred to as the progressive sequence, while a row of an image obtained by interlaced scanning is referred to as the interlaced sequence.

At this time, the interlaced picture is encoded in a field picture unit or a frame picture unit. That is, if it is encoded in a field unit, it is referred to as a field picture. If it is encoded in a frame unit, it is referred to as a frame picture.

In case of the interlaced field picture, one picture consists of an odd line of a scanning line while the other picture consists of an even line of a scanning line. Also, the operation of all the encoders and decoders is performed in a field unit. Accordingly, DCT blocks of 8×8 unit essentially consist of either an odd field or an even field. This is called a field DCT coded block.

By contrast, in case of the interlaced frame picture, each picture consists of an odd line of a scanning line and its even line. Accordingly, macro blocks of the frame picture have both an odd field and an even field.

At this time, the macro blocks of the frame picture can be coded by two different methods, i.e., a frame DCT coded block and a field DCT coded block.

The frame DCT coded block has four 8×8 DCT blocks within a macro block of 16×16, the four 8×8 DCT blocks being respectively provided with an odd line and an even line. On the other hand, the field DCT coded block has two 8×8 DCT blocks provided with an odd line only and two 8×8 DCT blocks provided with an even line only, within a macro block of 16×16.

In other words, the frame DCT coded block, as shown in FIG. 3a, divides a macro block into four blocks so that DCT is performed for each 8×8 block. The field DCT coded block, as shown in FIG. 3b, divides a macro block for each field to be divided into two blocks in pairs so that DCT is performed for each 8×8 block.

Furthermore, the macro blocks of the field picture are all coded by field DCT and motion-predicted from a reference field during motion compensation. However, the macro blocks of the frame picture are coded by both frame DCT and field DCT, and can be motion-compensated in either a frame unit or a field unit.

Meanwhile, in case of progressive sequence, all of pictures are coded by frame DCT and are frame-predicted.

At this time, most of the down conversion methods applied to a video decoder such as the conventional MPEG system have adopted down conversion in a DCT region. One of them is disclosed in U.S. Pat. No. 5,262,854. The U.S. Pat. No. 5,262,854 discloses a down sampler which eliminates 48 high frequency DCT coefficients within 8×8 block. For 4×4 block of other low frequency components, IDCT results are stored in a memory. Accordingly, when it is intended to reduce motion prediction error using full resolution motion vector during motion compensation, a screen of reduced resolution is used as a reference value. Finally, to make full resolution picture from reduced resolution, up-sampling method in horizontal and vertical directions is utilized.

Alternatively, several methods for reducing motion compensation prediction error by up-sampling a down-sampled picture with 4×4 IDCT have been suggested (see R. Morky and D. Anastassiou, “Minimal error drift in Frequency scalability for motion-compensated DCT coding,” IEEE Trans. On Circuit and System for Video Tech., Vol. 4, August 1994. Johnson and Princen, “Drift minimization in frequency scalable coders using block based filtering.” IEEE Workshop on Visual Signal Processing and Communication, September 1993).

The above suggested methods utilize a two-dimensional filter having 5 taps or 8 taps depending on motion vector of a typically predicted macro block. At this time, positions of values of an 8-tap filter are varied depending on motion vector. Accordingly, one 8-tap filter increases pixels from 4 to 8.

However, signals of interlaced HD grade, input to the video decoder, have several problems in case where they are displayed on an SD grade screen using the down conversion algorithm.

First, the above methods are suitable for progressive sequence having frame DCT coded blocks but not suitable for interlaced sequence having frame/field DCT coded blocks. That is, if the interlaced sequence is decoded in a picture unit, different frame DCT coded blocks and field DCT coded blocks exist in each block. In this case, to store the frame DCT coded blocks in a memory in a field unit, various processes and buffers are required. Loss also occurs during up-sampling and down-sampling in vertical direction.

Second, when a memory map is used in a field unit, up-sampling and down-sampling in vertical direction per field are required to compensate motion of frame prediction based on full motion vector. For this reason, a problem arises in that processing time of each field increases and thus a bandwidth of the memory increases. Also, for up/down-sampling in vertical direction, complexity of hardware is high.

Finally, in case of the interlaced sequence, a problem arises in that degradation of picture quality occurs due to loss of high frequency components of each field in vertical direction. When displaying respective fields in a frame unit by combining the fields with one another, discontinuous lines occur to be unpleasant to the eye.

### SUMMARY OF THE INVENTION

The present invention is derived to resolve the above and other problems and disadvantages of the related art and has an object to provide an apparatus for receiving a digital motion picture to display high density HD signals of an interlaced sequence on a reduced resolution screen of a standard definition while reducing memory and maintaining a good quality at a low cost.

In order to achieve the above objects and other advantages, according to the present invention, an apparatus for receiving a digital motion picture includes a video bit stream extracting part for separating and extracting a bit stream including a video signal, and a video display processor which performs down-conversion by converting the extracted video bit stream to a field DCT coded block if this video bit stream is an interlaced sequence with a frame DCT coded block, while performs the down- conversion as it is if the video bit stream has a field DCT coded block and stores the down conversion result in a memory for motion compensation.

The video display processor performs variable length decoding VLD and interlacing of the input bit stream and performs 4×4 IDCT after removing a DCT coefficient of a high frequency component in horizontal/vertical directions if the DCT coefficient is a field DCT type of an interlaced sequence, while performs down-sampling in a vertical direction in a converted field DCT domain after removing the DCT coefficient of the high frequency component in the horizontal direction and converting to a field DCT data if the DCT coefficient is a frame DCT type.

The video display processor performs up-sampling filtering in vertical/horizontal directions with relation to a data read from the memory before the motion compensation in case that a full resolution motion vector is utilized for the motion compensation, and performs down-sampling filtering in the vertical/horizontal direction after the motion compensation.

An apparatus for receiving a digital motion picture according to the present invention includes a down-sampling IDCT part for carrying out 4×4 inverse discrete cosine transform IDCT after removing a DCT coefficient of a high frequency component in horizontal/vertical directions if an inverse quantized DCT coefficient is a field DCT coded data, while performs down sampling of a frame DCT coded data in vertical direction in a DCT domain after removing the DCT coefficient of the high frequency component in horizontal direction to convert it to a field DCT coded data if the inverse quantized DCT coefficient is the frame DCT coded data, a memory for storing the IDCT data of the IDCT part or a result of adding the IDCT data with motion compensated data, an up-sampling part for carrying out up-sampling of a reference picture which is read from the memory in horizontal/vertical directions, a motion compensation part for carrying out motion compensation with relation to the picture which is up-sampled in horizontal/vertical directions in the up-sampling part by using a motion vector of a variable length decoded full resolution, a down-sampling part for carrying out down-sampling of the motion-compensated data in the motion compensation part in horizontal/vertical directions and storing in the memory by adding with the IDCT data, and a video display processor for reading the data stored in the memory according to a display mode to output to a display device.

The IDCT part includes a horizontal reduction part for removing the DCT coefficient of a high frequency component in horizontal direction if an input data is a frame DCT coded block of the interlaced sequence, a frame/field converter for converting the frame DCT coded block, of which DCT coefficient of the high frequency component in the horizontal direction is removed, to a field DCT coded block, a matrix multiplier for down-sampling the field DCT coded block in the vertical direction to output the IDCT coefficient in a field structure, and a horizontal IDCT for carrying out IDCT in the horizontal direction with relation to the output data from the matrix multiplier.

An apparatus for receiving a digital motion picture according to the present invention includes a video bit stream extracting part for separating and extracting a bit stream including a video signal, and a video processor for carrying out down-conversion of a DCT coded block and a field DCT coded block to a picture of a pixel structure based on a top field to store in a memory for carrying out motion compensation, if the extracted video bit stream is an interlaced sequence.

The video processor performs variable length decoding and inverse quantization for an input video bit stream and removes a DCT coefficient of a bottom field if the inverse-quantized DCT coefficient is a field DCT data of an interlaced sequence, and a DCT coefficient of a high frequency component of a top field, so as to carry out 8 by 4 inverse discrete cosine transform. In case of a frame DCT data as a result of the transform, the DCT coefficient of a high frequency component is removed in the horizontal direction and only the top field is extracted to carry out the IDCT.

An apparatus for receiving a motion picture according to the present invention, includes an IDCT part for carrying out 8×4 IDCT after removing a DCT coefficient of a bottom field and a DCT coefficient of a high frequency component of a top field if the inverse-quantized DCT coefficient is a field DCT data of an interlaced sequence, while removing a DCT coefficient of high frequency component in horizontal direction and extracting a top field only if the inverse-quantized DCT coefficient is a frame DCT data, a memory for storing the IDCT data of the IDCT part or a result of adding the IDCT data with motion compensated data, an up-sampling part for carrying out up-sampling of a reference picture which is read from the memory in horizontal direction, a motion compensation part for carrying out motion compensation with relation to the picture which is up-sampled in horizontal direction in the up-sampling part by using a motion vector of a VLD full resolution, a down-sampling part for carrying out down-sampling for the data of which motion is compensated in the motion compensation part in horizontal direction and storing in the memory by adding with the IDCT data, and a video display processor for reading the data stored in the memory according to a display mode to output to a display device.

The IDCT part includes a horizontal reduction part for removing the DCT coefficient of a high frequency component in horizontal direction if an input data is a frame DCT coded block of the interlaced sequence, a converter for converting the frame DCT coded block, of which DCT coefficient of the high frequency component is reduced in the horizontal direction, to a field DCT coded block so as to output IDCT coefficient of the top field only, and a horizontal IDCT for carrying out IDCT in the horizontal direction with relation to the output data from the converter.

Now, further objects, characteristics and advantages of the present invention will be apparent from the following description of preferred embodiments of the present invention in conjunction with the accompanying drawings.

### BRIEF DESCRIPTION OF THE DRAWINGS

FIG. 1 is a block diagram showing structure of a related art digital TV receiver;

FIG. 2 is a detailed block diagram of an MPEG video decoder of FIG. 1;

FIG. 3a and FIG. 3b are views showing respective frame DCT and field DCT processes;

FIG. 4 is a block diagram of an MPEG video decoder according to a first preferred embodiment of the present invention;

FIG. 5 is a detailed block diagram of FIG. 4;

FIG. 6a and FIG. 6b are views respectively showing a pixel structure of a field based reference picture and a frame based reference picture after down-sampling in a DCT area;

FIG. 7 is a detailed block diagram of an IDCT part and a down-sampling part of FIG. 4;

FIG. 8 is a block diagram showing motion compensation through up/down sampling of FIG. 4;

FIG. 9 is a block diagram of up/down sampling utilized in the motion compensation of FIG. 4;

FIG. 10 is a view showing an example that a bottom field is vertically interpolated after the down sampling in the DCT area;

FIG. 11 is a block diagram of an MPEG video decoder according to a second preferred embodiment of the present invention;

FIG. 12 is a detailed block diagram of FIG. 11;

FIG. 13 is a detailed block diagram of an adaptive IDCT part of FIG. 11;

FIG. 14 is a block diagram showing a motion compensation process through the up/down sampling of FIG. 11.

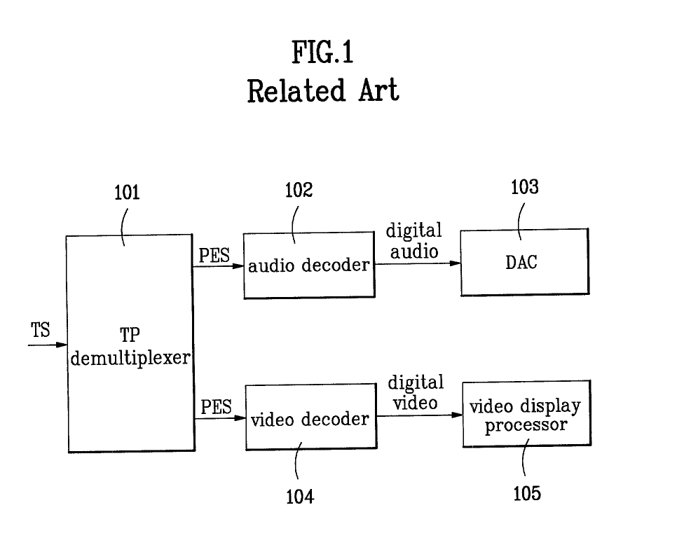

### DESCRIPTION OF THE PREFERRED EMBODIMENTS

Now, preferred embodiment of the present invention will be described in more detail with reference to the accompanying drawings.

The present invention will be described in conjunction with first and second preferred embodiments.

First Preferred Embodiment

In a first preferred embodiment of the present invention, a received DCT block is down-sampled in case of a field DCT coded block or converted into a field DCT coded block to be down-sampled in case of a frame DCT coded block, and then the down-sampled DCT block is stored in a memory for motion compensation.

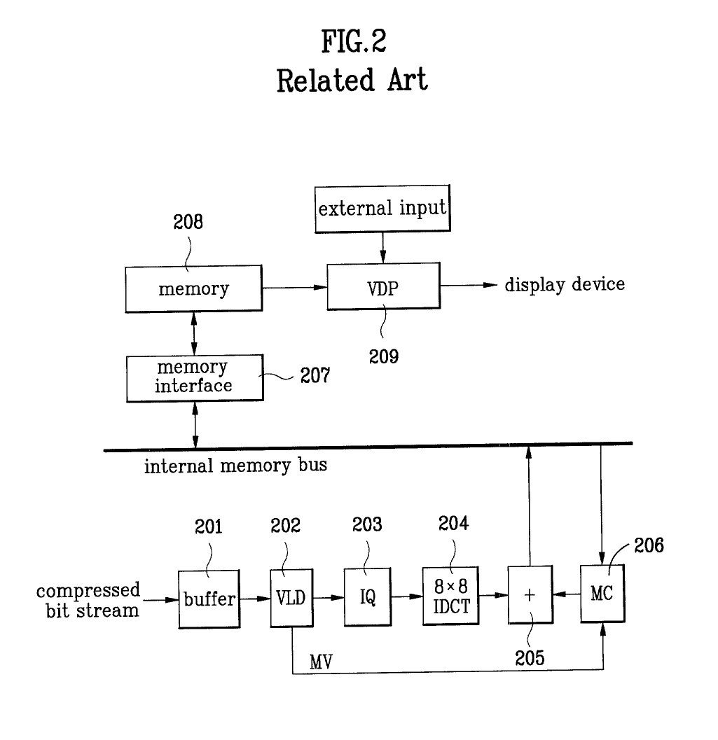

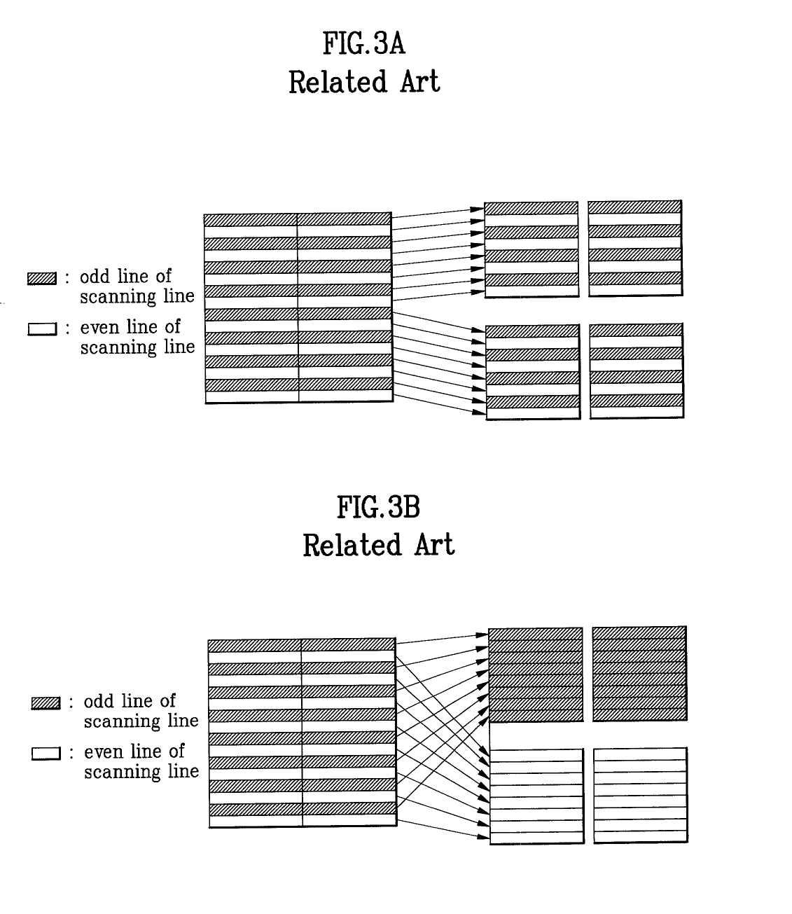

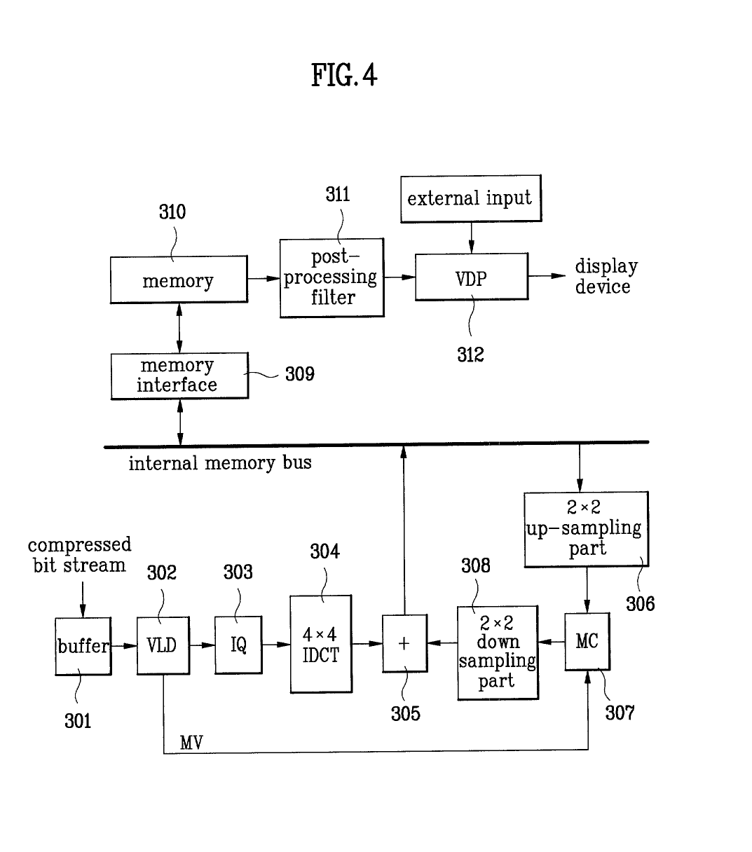

FIG. 4 is a block diagram showing a structure of an MPEG-2 video docoder having a down-conversion for 75% memory reduction as proposed in the first embodiment, which further includes an IDCT and down-sampling part 304, an up-sampling part 306, and a down sampling part 308 in addition to the components as shown in FIG. 2.

The IDCT and down sampling part 304 performs IDCT differently according to whether a macro block input via an IQ part 303 is a field DCT coded block or a frame DCT coded block and outputs the IDCT result to an adder 305. The up-sampling part 306 performs up-sampling of the data read from a memory 310 in horizontal/vertical directions to output to a motion compensation part 307. The down-sampling part 308 performs down-sampling of the motion compensated data from the motion compensation part 307 in the horizontal/vertical directions again and outputs the result to the adder 305. The adder 305 adds the data which is output from the IDCT and down-sampling part 304 with a data output from the down-sampling part 308 and stores the added data in the memory 310 via an internal memory bus and a memory interface 309.

That is, a compressed bit stream is input to a VLD part 302 via a buffer 301 to be variable length decoded. Such a bit stream variable length decoded via the VLD part 302 is stored in the external memory 310 via the IQ part 303, the IDCT and down sampling part 304 and the motion compensation part 307. An image stored in the external memory 310 is displayed on a screen via a video display processor VDP 312.

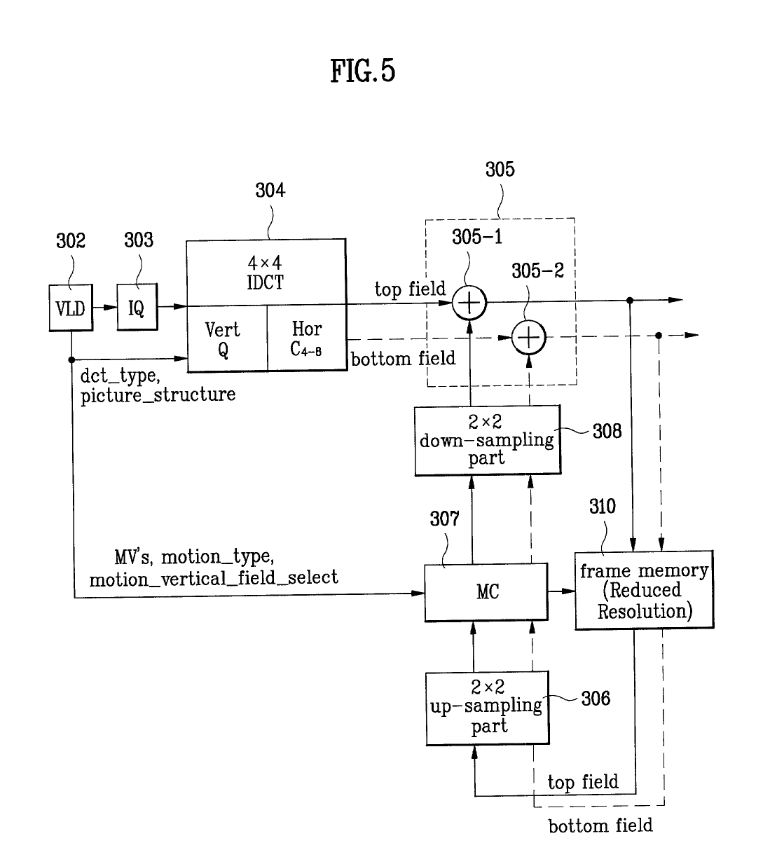

FIG. 5 is a block diagram which shows a down-conversion part of FIG. 4 in more detail, in which a memory has a field structure.

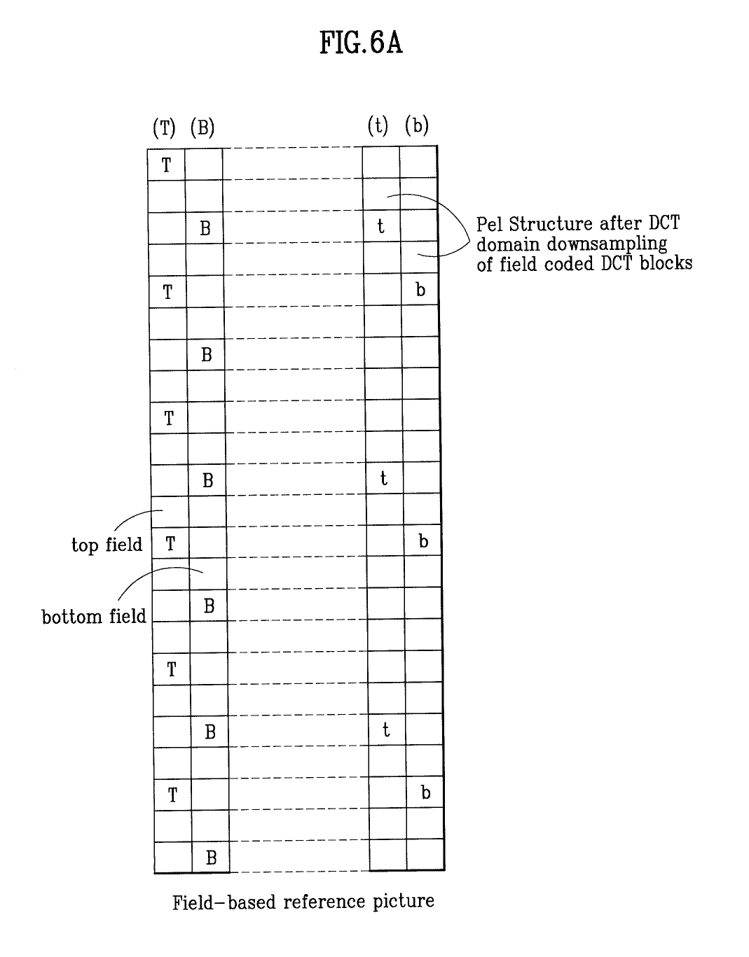

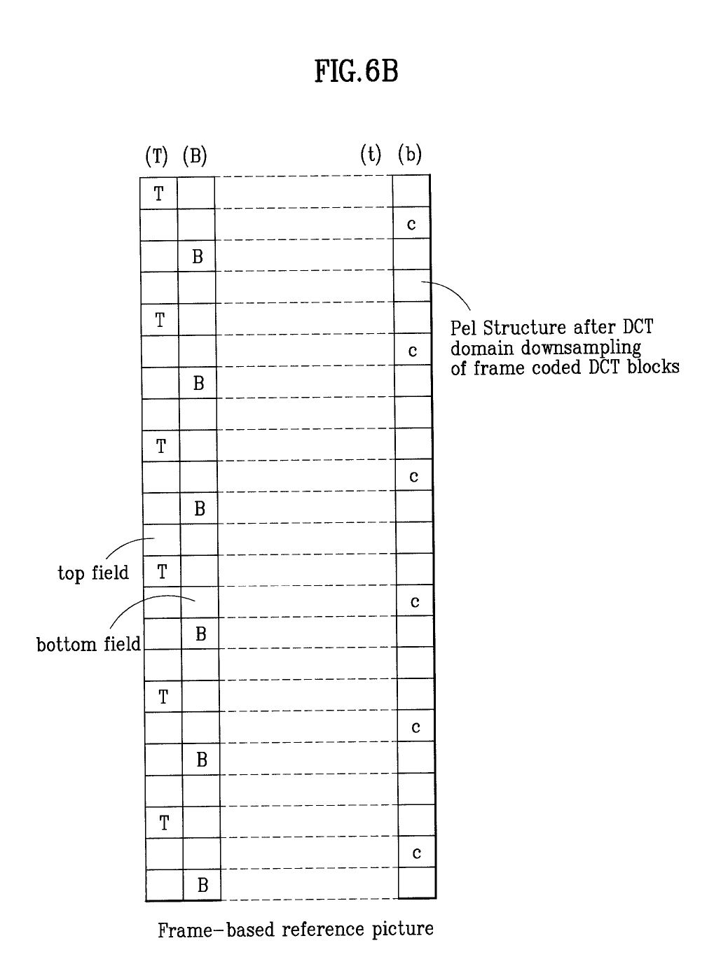

As shown in FIG. 6a and FIG. 6b, down-sampling results in a DCT conversion area of a field DCT coded block and a frame DCT coded block have different pixel structures from each other.

Therefore, in the first preferred embodiment of the present invention, a preset field-based reference picture may be obtained always regardless of the input DCT types. In order to obtain such field-based reference picture, the IDCT and down sampling part 304 converts the frame DCT coded block to the field DCT coded block to perform the IDCT and down-sampling, if the frame DCT coded block is input.

DCT coefficients generated from the VLD part 302 are input to the IQ part 303 and transmitted to the IDCT part 304 after inverse-quantization, wherein the VLD part 302 provides dct-type, which represents a frame DCT coded block or a field DCT coded block, and a picture_structure, which represents a frame picture or a field picture simultaneously. Further, the VLD part 302 provides to the motion compensation part 307 with motion vectors MV, motion types (motion_type), and field selection signals (motion_vertical_field_select).

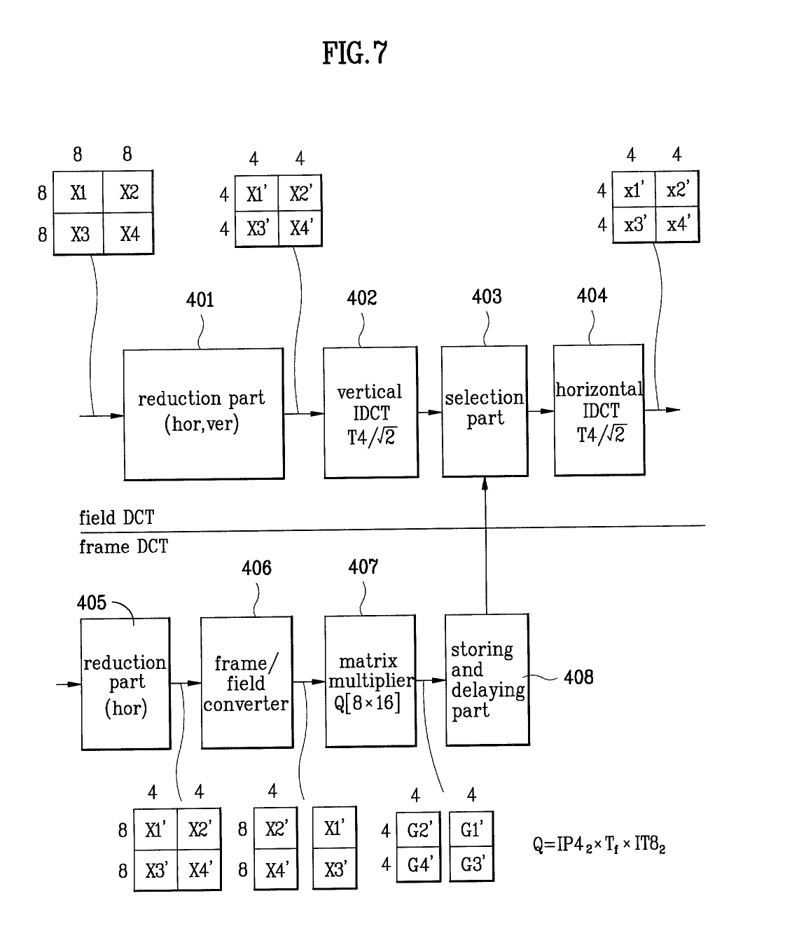

FIG. 7 shows operation of the IDCT and down sampling part 304.

If an input data is a field DCT coded macro block, the IDCT and down-sampling part 304 removes DCT coefficients (X(I,J),I=5, . . . ,8, J=5, . . . ,8) corresponding to high frequency components among 8×8 IDCT coefficients in vertical/horizontal direction and performs IDCT for remaining 4×4 DCT coefficients only in vertical/horizontal direction.

In this case, only low frequency components are restored so that the definition, that is, information on detail edges of images or text may be lost. The picture quality is, however, not severely damaged since most natural images are concentrated with signals for the low frequency area. Therefore, the result of 4×4 IDCT has an effect of using a low frequency bandwidth filter for the images, and finally, the size of the image to be stored in the external memory 310 is reduced by ¼, obtaining a memory reduction ratio of 75%.

On the other hand, if the input data is the frame DCT coded block, the IDCT and down-sampling part 304 converts the frame DCT coded block to the field DCT coded block and performs the down-sampling and IDCT in the range of the DCT conversion. Therefore, an output from the IDCT and down-sampling part 304 has always the field-based vertical structure as shown in FIG. 6. The output from the IDCT and down-sampling part 304 are input to the MB adder 305.

At this time, formula 1 for performing the IDCT of the frame DCT coded block to the field DCT coded block in vertical direction in the IDCT and down-sampling part 304 is as follow:

$$[ X ] = [ \begin{matrix}[ \begin{matrix}X \\ X \\ X \\ X \\ X \\ X \\ X \\ X\end{matrix} ] \\ [ \begin{matrix}X \\ X \\ X \\ X \\ X \\ X \\ X \\ X\end{matrix} ]\end{matrix} ] \qquad \text{(formula 1)}$$

wherein, [X] represent two vertical blocks having eight frame DCT coefficients.

Below formula 2 represents 8×8 DCT basis matrix.

$$[ T8 ] = [ \begin{matrix}{t}_{00} {t}_{01} {t}_{02} {t}_{03} {t}_{04} {t}_{05} {t}_{06} {t}_{07} \\ {t}_{10} {t}_{11} {t}_{12} {t}_{13} {t}_{14} {t}_{15} {t}_{16} {t}_{17} \\ {t}_{20} {t}_{21 } {t}_{22} {t}_{23} {t}_{24} {t}_{25} {t}_{26} {t}_{27} \\ {t}_{30 } {t}_{31} {t}_{32} {t}_{33} {t}_{34} {t}_{35} {t}_{36} {t}_{37} \\ {t}_{40} {t}_{41} {t}_{42} {t}_{43} {t}_{44} {t}_{45} {t}_{46} {t}_{47} \\ {t}_{50} {t}_{51} {t}_{52} {t}_{53} {t}_{54} {t}_{55} {t}_{56} {t}_{57} \\ {t}_{60} {t}_{61} {t}_{62} {t}_{63} {t}_{64} {t}_{65} {t}_{66} {t}_{67}\end{matrix} ] \qquad \text{(formula 2)}$$

That is, [T8] represent 8×8 DCT basis matrix consisting of 8-point DCT basis.

At this time, IDCT with relation to the two vertical blocks are represented by following formula 3.

$$[ {IT8}_{2} ] = [ \begin{matrix}{T8}^{T} & 0 \\ 0 & {T8}^{T}\end{matrix} ] \qquad \text{(formula 3)}$$

Finally, a result of the IDCT of [X] is represented by formula 4.

$$[ x ] = [ \begin{matrix}[ \begin{matrix}x \\ x \\ x \\ x \\ x \\ x \\ x \\ x\end{matrix} ] \\ [ \begin{matrix}x \\ x \\ x \\ x \\ x \\ x \\ x \\ x\end{matrix} ]\end{matrix} ] = [ {IT8}_{2} ] [ X ] \qquad \text{(formula 4)}$$

wherein, [x] represents two vertical blocks of pixel unit.

A DCT matrix for converting the frame to the field is as represent by formula 5.

$${T}_{f} = [ \begin{matrix}\begin{matrix}\vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}} & \vec{0}\end{matrix} \\ \begin{matrix}\vec{0} & \vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}}\end{matrix}\end{matrix} ] \qquad \text{(formula 5)}$$

wherein, \vec{t}₁ represents i-th 8-point DCT basis vector.

At this time, formula 5 is rearrangement of 8-point DCT basis vectors in a colunmn direction of a matrix of formula 2 properly to a top and a bottom for separating the top and bottom from the frame DCT block. In an upper part of the matrix of formula 5, the 8-point DCT basis vectors are arranged one-by-one properly to the top, while in a lower part, the 8-point DCT basis vectors are arranged every other one.

Accordingly, if the frame DCT block is multiplied by formula 5, the DCT coded result comes by a field unit as shown by formula 6, which is the same that the top and the bottom are separately DCT coded.

$$[ {T}_{f} ] [ x ] = [ \begin{matrix}[ \begin{matrix}Xt \\ Xt \\ Xt \\ Xt \\ Xt \\ Xt \\ Xt \\ Xt\end{matrix} ] \\ [ \begin{matrix}Xb \\ Xb \\ Xb \\ Xb \\ Xb \\ Xb \\ Xb \\ Xb\end{matrix} ]\end{matrix} ] = [ Xtb ] \qquad \text{(formula 6)}$$

wherein, [x] is arranged in the order of frame, [Xtb] represents two field DCT coded blocks with relation to the top and bottom fields.

Therefore, by using the above formulae, the frame DCT coefficients [x] are represented by field DCT coefficients [Xtb] as shown by formula 7.

[Xtb]=[T_{f}][x]=[T_{f}][IT8₂][X] (Formula 7)

In conclusion, the down-sampling method of the DCT conversion area is the result of IDCT after removing the high frequency components of the field DCT coded coefficients in vertical/horizontal direction. Therefore, [Xtb] becomes 4×4 IDCT coded by using following operators.

First of all, similarly to the above formula 2, a 4×4 DCT matrix consisting of 4-point DCT basis is assumed to be [T4]. Then, the process that carrying out the down-sampling after removing the high frequency components in horizontal/vertical direction is represented by formula 8.

$$[ \begin{matrix}y \\ y \\ y \\ y \\ 0 \\ 0 \\ 0 \\ 0\end{matrix} ] = [ {P4}^{T} ] [ \begin{matrix}X \\ X \\ X \\ X \\ X \\ X \\ X \\ X\end{matrix} ] \qquad \text{(formula 8)}$$

wherein, [P4] is represented by following formula 9.

$$[ P4 ] = [ \begin{matrix}T4 & 0 \\ 0 & 0\end{matrix} ] / \sqrt{2} \qquad \text{(formula 9)}$$

A down-sampled IDCT coefficient with relation to the [Xtb] of formula 7 is represented by following formula 10.

$$[ ytb ] = [ \begin{matrix}yt \\ yt \\ yt \\ yt \\ yb \\ yb \\ yb \\ yb\end{matrix} ] = [ {IP4}_{2} ] [ Xtb ] = [ {IP4}_{2} ] [ \begin{matrix}yt \\ yt \\ yt \\ yt \\ yt \\ yt \\ yt \\ yt \\ yb \\ yb \\ yb \\ yb \\ yb \\ yb \\ yb \\ yb\end{matrix} ] \qquad \text{(formula 10)}$$

wherein, [IP4₂] is a down-sampling matrix of field DCT coded coefficients and represented by formula 11.

$$[ {IP4}_{2} ] = [ \begin{matrix}{T4}^{T} & 0 & 0 & 0 \\ 0 & 0 & 0 & {T4}^{T}\end{matrix} ] / \sqrt{2} \qquad \text{(formula 11)}$$

The frame DCT coded coefficients [X] by using formula 7 and formula 10 obtain pixels [ytb] of field unit which were subject to the conversion to a field DCT coded coefficients and the down-sampling as shown by formula 12.

[ytb]=[Q][X]=[IP4₂][T_{f}][IT8₂][X] (Formula 12)

wherein, [Q]=[IP4₂][T_{f}][IT8₂] is a 8×16 matrix, which operates for DCT coefficients of vertical direction only.

Now, the macro blocks, that is four 8×8 DCT blocks X1,X2,X₃,X4 will be described in more detail with reference to FIG. 7.

If an input data is a field DCT coded block, 4×4 IDCT is performed in respective vertical and horizontal directions for the respectively blocks X1′,X2′,X3′,X4′, of which high frequency components are removed in vertical/horizontal direction.

In order to achieve the above 4×4 IDCT, field DCT coded macro blocks are input to a first reduction part 401. The first reduction part 401 removes DCT coefficients (X(I,J),I=5, . . . ,8, J=5, . . . ,8) corresponding to the high frequency components in vertical/horizontal direction among 8×8 IDCT coefficients of the field DCT coded macro blocks X1,X2,X3,X4 and inputs the other 4×4 DCT coefficients X1′,X2′,X3′,X4′ to a vertical IDCT part 402 for carrying out IDCT in vertical direction. The result of the IDCT in the vertical direction is output to a horizontal IDCT part 404 for carrying out IDCT in horizontal direction.

On the other hand, if the input data is the frame DCT coded MB block, the input data is input to a second reduction part 405. The second reduction part 405 removes DCT coefficients (X(I,J),I=1, . . . ,8, J=5, . . . ,8) corresponding to the high frequency components in horizontal direction among 8×8 IDCT coefficients of the frame DCT coded macro blocks X1,X2,X3,X4 and outputs the other 8×4 DCT coefficients X1′,X2′,X3′,X4′ to a frame/field converter 406. The frame/field converter 406 converts the frame DCT coded block to a field DCT block of which top/bottom are distinguished as shown by formula 7 and outputs to a matrix multiplier 407. The matrix multiplier 407 obtains IDCT coefficients which were down-sampled in vertical direction by using matrix [Q] of formula 12, that is, blocks G1′,G2′,G3′,G4′ of the field structure. The field structured blocks G1′,G2′,G3′,G4′ are input to a horizontal IDCT part 404 via a selection part 403 after being temporarily stored and delayed in a storing and delay part 408. That is, field-based pixels x1′,x2′,x3′,x4′ of vertical structure may be finally obtained with relation to the frame DCT coded blocks, wherein (x1′,x2′) represents a top field block while (x3′,x4′) represents a bottom field block. In case of an Intra-picture (I-picture), the result is directly stored in the memory 310 via the IDCT and down-sampling part 304. On the other hand, incase of a Predictive picture (P-picture) or Bidirectional picture (B-picture), the data motion compensated by motion prediction are added to an adder and then the resultant value is stored in the memory 310.

In the meantime, a general video encoder utilizes a full resolution motion vector is utilized to obtain the motion compensated frame, and a current frame block is reproduced from a previous frame.

Therefore, in the first preferred embodiment of the present invention, the full-resolution motion vectors are utilized rather than scaling down motion vectors in vertical/horizontal direction in order to increase the screen quality in case of the motion compensation.

In order to use the full-resolution motion vectors, up-sampling process is required for restoring a reduced reference picture in the memory 310 to an original resolution. Further, a down-sampling process for reducing the original resolution to ¼ resolution after the motion compensation, which are performed by an up-sampling part 306, a motion compensation part 307, and a down-sampling part 308 of FIG. 4.

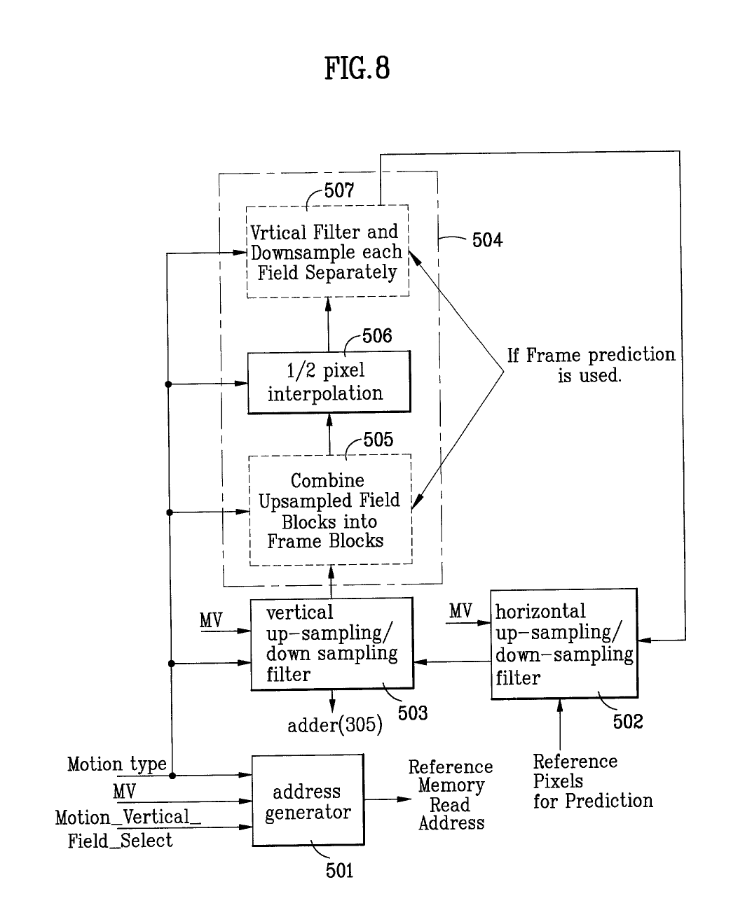

FIG. 8 is a block diagram showing up/down sampling and motion compensation process according to a first embodiment of the present invention, which is a detailed block diagram showing the up-sampling part 306, the motion compensation part 307 and the down-sampling part 308 of FIG. 4.

Referring to FIG. 8, the motion compensation part 504 includes a coupling part 505, a half-pel interpolation part 506 and a field separation part 507.

The coupling part 505 and the field separation part 507 bypass input data in case of motion compensation by using field prediction and respectively carry out coupling and separation operation in case of motion compensation by using frame prediction. The horizontal up/down sampling filter 502 and the vertical up/down sampling filter 503 are respectively corresponding to a detailed block diagram of the up-sampling filter 306 and the down-sampling part 308 of FIG. 4.

As described above, the memory 310 stores a picture of the field-based vertical structure. The horizontal/vertical up-sampling part 306 selects fields proper for the motion vectors in case of the motion compensation and carry out up-sampling in horizontal/vertical direction respectively for the fields read from the reduced field reference signals in the memory 310.

As shown in FIG. 8, the motion compensation is divided into the frame prediction and the field prediction according to motion_type.

In case of the motion compensation by using the field prediction, an address generating part 501 sends a read address to the reference memory 310 by using the motion vectors, motion-_type signals and motion_vertical_field_select signals. Then, the reference memory 310 reads reference blocks of corresponding fields which are stored in the read address and outputs to the horizontal/vertical up-sampling filters 502, 503 of the up-sampling part 306. At this time, the horizontal/vertical up-sampling filters 502, 503 carry out up-sampling in the horizontal/vertical directions with relation to the blocks of the read blocks and output to the half-pel interpolation part 506 of the motion compensation part 504. The half-pel interpolation part 506 composes motion compensated blocks by half-pel interpolation for the up-sampled blocks and outputs to the horizontal/vertical down-sampling filters 502,503 of the down-sampling part 308. The horizontal/vertical down-sampling filters 502, 503 carry out the down-sampling in the horizontal/vertical directions for the motion compensated blocks by the respective field unit and output to the macro block adder 305.

In the meantime, in case of the motion compensation by using the frame prediction, the address generating part 501 sends a read address to the reference memory 310 by using the motion vectors, motion-_type signals and motion_vertical_field_select signals. Then, the reference memory 310 reads reference blocks of the field unit which are stored in the read address and outputs to the horizontal/vertical up-sampling filters 502, 503 of the up-sampling part 306. At this time, the horizontal/vertical up-sampling filters 502, 503 carry out up-sampling in the horizontal/vertical directions with relation to the top and bottom fields to output to the coupling part 505. The coupling part 505 makes a frame block from the two input fields to output to the half-pel interpolation part 506. The half-pel interpolation part 506 composes motion compensated blocks by half-pel interpolation to output to the horizontal/vertical down-sampling filters 502,503 of the down-sampling part 308. The horizontal/vertical down-sampling filters 502, 503 carry out the down-sampling in the horizontal/vertical directions for the separated fields and output to the macro block adder 305.

Wherein, the address generating part 501 receives motion vectors, motion_type, and motion_vertical_field_select input from the VLD part 302 to provide the corresponding signals to required parts and the reference memory 310 generates the read address. Then, the data which is stored in the read address is read from the reference memory 310 and output to the motion compensation part 504 as the reference pixels for the prediction via the horizontal/vertical up-sampling filters 502, 503.

The picture quality of the motion compensated picture depends on the characteristics of the up/down sampling filters 502, 503 in the horizontal/vertical directions of the up/down sampling parts 306, 308. The up-sampling/down-sampling filter system employed in the first preferred embodiment of the present invention utilize matrices composed of DCT bases.

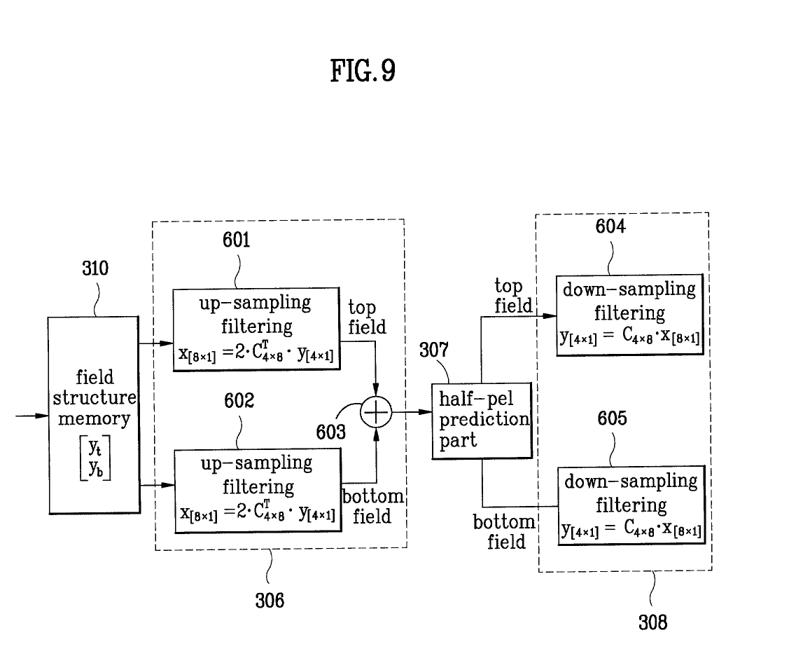

FIG. 9 is a block diagram for showing the motion compensation of respective field signals from the memory in the field based structure, in which the top field data and the bottom field data are separately stored so that the up-sampling and the down-sampling are individually carried out for the top field and the bottom field.

First of all, one-dimensional down-sampling is represented by formula 13 by using the above formula 2 and formula 8.

y_{[4×1]}=C₄^{T}·X_{[8×1]}=[T4^{T}0]/\sqrt{2}·[T₈]·x_{[8×1]} (Formula 13)

wherein, x represents 8×1 pixels, y represents down-sampled 4×1 pixels, X represents DCT coded coefficient blocks for x, and T₈ represents 8×8 DCT basis matrix. Further,

$${C}_{4} = [ \begin{matrix}{T}_{4} \\ 0\end{matrix} ] / \sqrt{2} ,$$

and T₄ represents 4×4 DCT basis matrix.

Therefore, the above formula 13 may be represented by following formula 14.

y_{[4×1]}=C_{[4×8]}·x_{[8×1]} (Formula 14)

wherein, C_{[4×8]}=C₄^{T}·T₈ is defined by 4×8-dimensional down-sampling matrices, and eight pixels are converted into four pixels.

On the other hand, the up-sampling system is formed of inverse-conversion of the above formulae for the down-sampling, wherein four pixels are converted into eight pixels. First of all, eight DCT coefficients are obtained by the above formula 13, which may be represented by formula 15 as follows.

$${X}_{[ 4 \times 1 ]}^{′} = [ \begin{matrix}T4 \\ 0\end{matrix} ] \cdot \sqrt{2} \cdot {y}_{4 \times 1} = {C}_{4} \cdot {y}_{4 \times 1} \cdot 2 \qquad \text{(formula 15)}$$

The 8-point IDCT result by using the above formula 15 may be obtained by formula 16 as follows.

x_{[8×1]}^{up}=T₈^{T}·X^{|}_{[8×1]} (Formula 16)

Finally, the above formula 15 and formula 16 may be represented by formula 17 as follows.

x_{[8×1]}^{up}=T₈^{T}·C₄·y_{4×1}·2=2=2·C_{4×8}^{T}y_{4×1} (Formula 17)

The above formula 17 represents the up-sampling process of ½ resolution picture, which is stored in the memory 310, to an original picture.

If the macro blocks are reproduced for the original resolution by carrying out the up-sampling in the horizontal/vertical directions by using the up-sampling matrices of the above formula 17, the blocks for the motion compensation may be obtained. That is, a first up-sampling filter part 601 reads blocks of the top field from the memory 310 and carries out the up-sampling to reproduce the macro blocks for the original resolution, a second up-sampling filter part 602 reads blocks of the bottom field from the memory and carries out the up-sampling to reproduce the macro blocks for the original resolution. If the top and bottom fields which are up-sampled in the first and second up-sampling filter parts 601, 602 are added in an adder 603, the blocks for the motion compensation may be obtained.

If the half-pel interpolation exists in the horizontal direction or full resolution motion vectors are not decreased below a multiple of 8, the first and second up-sampling filter parts 601, 602 read environmental blocks of 4×4 units in the horizontal/vertical directions from the memory 310. Then, as induced in the formula 17, full-resolution blocks are restored for the blocks in the respective vertical/horizontal directions by using the up-sampling matrices. The motion compensation part 307 carries out the half-pel interpolation for areas corresponding to the full-resolution motion vectors to obtain desired motion compensated blocks.

In order to add the motion compensated macro blocks with 4×4 IDCT results in the adder 305, the down-sampling is carried out for the motion compensated macro blocks again.

If the down-sampling is carried out for the motion compensated macro blocks in the horizontal/vertical directions by using the down-sampling matrices of the above formula 14, macro blocks having a ½ size in the horizontal/vertical directions may be obtained. That is, the first down-sampling filter part 604 and the second down-sampling filter part 605 respectively carry out the down-sampling for the motion compensated top field and the motion compensated bottom field, so that the macro blocks having ½ size in the horizontal/vertical directions are output.

The blocks obtained as above are stored in the memory 310 again via the MB adder 305, wherein the blocks are added by the field unit.

As shown in FIG. 4, the reduced-resolution pictures are displayed on the screen via the VDP 312 according to various display modes.

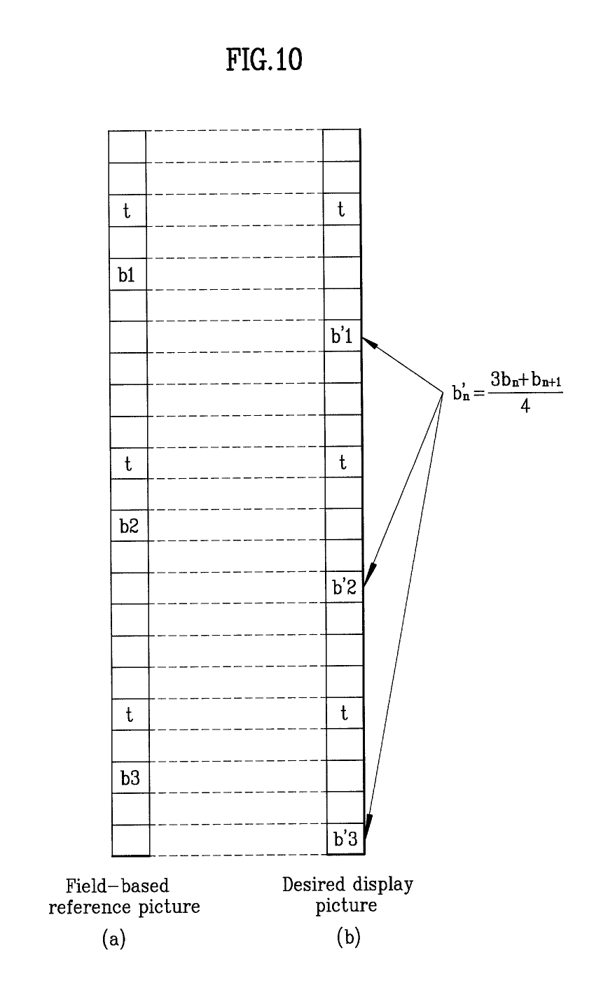

As shown in FIG. 10a, the position of the bottom field in the reduced-resolution picture which is stored in the memory 310 is not a position of a desired display and accordingly to be amended by using a post-processing filter 311 in the vertical direction, wherein the filter uses a simple average value as shown in FIG. 10 or a FIR filter of 4-tap is utilized.

Further, slight blocking artifact may be generated due to the loss in the process of the down-sampling after the 4×4 IDCT or the motion compensation. In order to amend such blocking artifact, a 9-tap FIR filter may be utilized in the process of the post-processing to increase a continuity of border surfaces, thereby improving the screen quality.

Second Preferred Embodiment

In second first preferred embodiment of the present invention, a received field DCT coded blocks and frame DCT coded blocks of interlaced scanning sequence are subject to down-convergence to a picture having fixed top field pixels and then the down-sampled DCT blocks are stored in a memory for motion compensation, wherein signals which are ½ times of high density signals in horizontal direction may be obtained without adding any further processors.

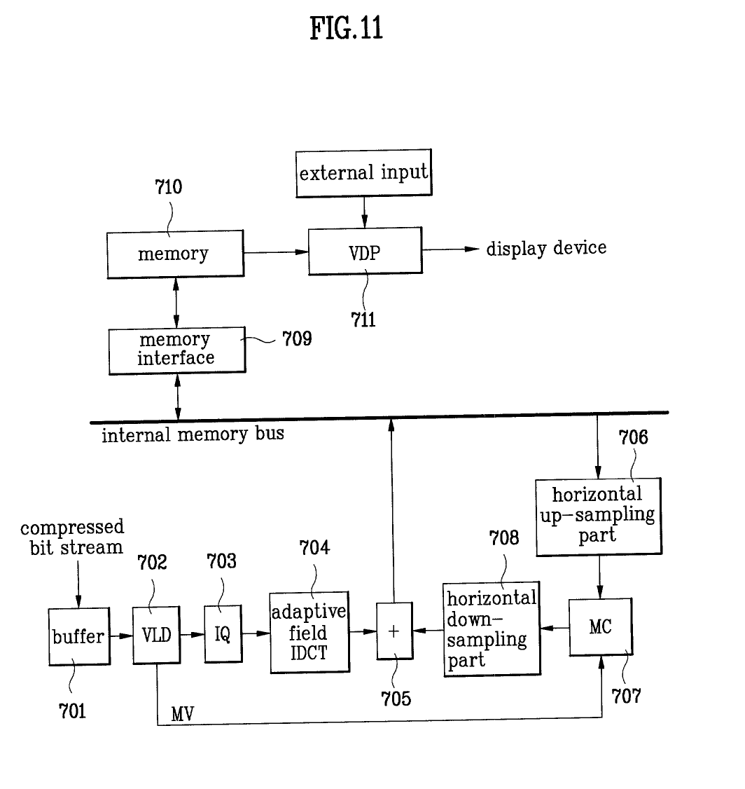

FIG. 11 is a block diagram showing a structure of an MPEG-2 video docoder having a down-conversion for 75% memory reduction as proposed in the present invention, which further includes an adaptive IDCT part 704, an up-sampling part 706, and a down sampling part 708 in addition to the components as shown in FIG. 2.

The adaptive IDCT 704 performs IDCT for a top field only regardless of DCT types of macro blocks input from an IQ part 703. The up-sampling part 706 performs up-sampling of the data read from a memory 710 in horizontal direction to output to a motion compensation part 707. The down-sampling part 708 performs down-sampling of the motion compensated data from the motion compensation part 707 in the horizontal direction again and outputs the result to the adder 705. The adder 705 adds the data, which is output from the adaptive IDCT part 704, to a data output from the down-sampling part 708 and stores the added data in the memory 710 via an internal memory bus and a memory interface 709.

That is, a compressed bit stream is input to a VLD part 702 via a buffer 701 to be variable length decoded. Such a bit stream variable length decoded via the VLD part 302 is stored in the external memory 710 via the IQ part 703, the adaptive IDCT part 704 and the motion compensation part 707. An image stored in the external memory 710 is displayed on a screen via a video display processor VDP 712.

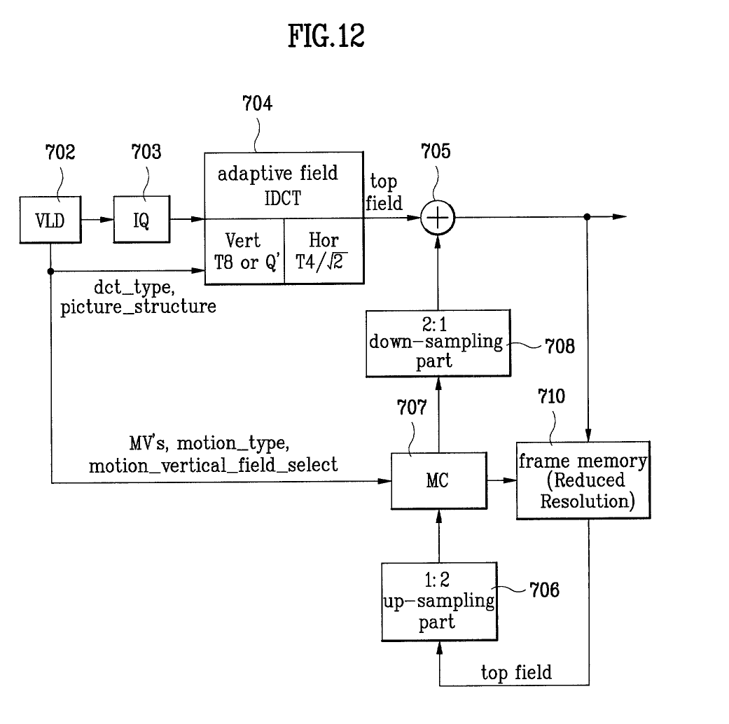

FIG. 12 is a block diagram which shows a down-conversion part of FIG. 11 in more detail, in which a memory has a field structure.

In the second preferred embodiment of the present invention, the fixed top field-based-reference picture may be always obtained regardless of the received DCT types.

In order to obtain such field-based-reference picture, the IDCT is carried out the top field only if the field DCT coded block is input, and the frame DCT coded block is converted into the field DCT coded block to perform the IDCT for the top field only if the frame DCT coded block is input, thereby obtaining 50% memory reduction effect. At this time, if 75% memory reduction is required, DCT coefficients corresponding to the high frequency components in the horizontal direction are removed before the IDCT.

DCT coefficients generated from the VLD part 702 are input to the IQ part 703 and transmitted to the adaptive IDCT part 704 after inverse-quantization, wherein the VLD part 702 provides dct-type, which represents a frame DCT coded block or a field DCT coded block, and a picture_structure, which represents a frame picture or a field picture simultaneously. Further, the VLD part 702 provides to the motion compensation part 707 with motion vectors MV, motion types (motion_type), and field selection signals (motion_vertical_field_select).

FIG. 12 shows operation of the adaptive IDCT part 704.

If an input data is a field DCT coded macro block, the adaptive IDCT part 704 removes DCT coefficients (X(I,J),J=5, . . . ,8) corresponding to high frequency components in horizontal direction among 8×8 IDCT coefficients (X1,X2) and performs IDCT for remaining 8×4 DCT coefficients only in vertical/horizontal directions.

In this case, only low frequency components are restored so that the definition in the picture, that is, information on detail edges of images or text may be lost. The picture quality is, however, not severely damaged since most natural images are concentrated with signals for the low frequency area. Therefore, the result of 8×4 IDCT has an effect of using a low frequency bandwidth filter for the images. Further, the DCT coefficients corresponding to the bottom fields among the macro blocks are disposed, which results in the display of the top fields only in a display device. Finally, the size of the image to be stored in the external memory is reduced by ¼, obtaining a memory reduction ratio of 75%.

On the other hand, if the input data is the frame DCT coded block, signals corresponding to the top fields are selected to carry out the IDCT in the vertical/horizontal directions, thereby carrying out ½ down-sampling in the horizontal direction in the range of the IDCT. Therefore, an output of the adaptive IDCT part 704 has always the top field-based pixel structure and the output from the adaptive IDCT part 704 are input to the MB adder 705.

At this time, formula 18 for performing the IDCT of the frame DCT coded block to the top field DCT coded block in vertical direction in the adaptive IDCT part 704 is as follow:

$$[ X ] = [ \begin{matrix}X \\ X \\ X \\ X \\ X \\ X \\ X \\ X\end{matrix} ] \qquad \text{(formula 18)}$$

wherein, [X] represents vertical blocks having eight frame DCT coefficients.

8×8 DCT basis matrix [T8] is represented by formula 19.

$$[ T8 ] = [ \begin{matrix}{t}_{00} {t}_{01} {t}_{02} {t}_{03} {t}_{04} {t}_{05} {t}_{06} {t}_{07} \\ {t}_{10} {t}_{11} {t}_{12} {t}_{13} {t}_{14} {t}_{15} {t}_{16} {t}_{17} \\ {t}_{20} {t}_{21} {t}_{22} {t}_{23} {t}_{24} {t}_{25} {t}_{26} {t}_{27} \\ {t}_{30} {t}_{31} {t}_{32} {t}_{33} {t}_{34} {t}_{35} {t}_{36} {t}_{37} \\ {t}_{40} {t}_{41} {t}_{42} {t}_{43} {t}_{44} {t}_{45} {t}_{46} {t}_{47} \\ {t}_{50} {t}_{51} {t}_{52} {t}_{53} {t}_{54} {t}_{55} {t}_{56} {t}_{57} \\ {t}_{60} {t}_{61} {t}_{62} {t}_{63} {t}_{64} {t}_{65} {t}_{66} {t}_{67}\end{matrix} ] \qquad \text{(formula 19)}$$

wherein, [T8] represents 8×8 DCT matrix consisting of 8-point DCT bases.

Finally, the IDCT result of [X] may be represented by following formula 20.

$$[ x ] = [ \begin{matrix}xt \\ xb \\ xt \\ xb \\ xt \\ xb \\ xt \\ xb\end{matrix} ] = [ {T8}^{T} ] [ X ] \qquad \text{(formula 20)}$$

wherein, [x] represents vertical blocks of the frame structure, wherein top fields may be obtained by converting the frame DCT coefficients to the IDCT coefficients of the field structure by using formula 21.

$$[ Xt ] = [ \begin{matrix}xt \\ 0 \\ xt \\ 0 \\ xt \\ 0 \\ xt \\ 0\end{matrix} ] = [ {I}_{f} ] [ x ] = [ \begin{matrix}10000000 \\ 00000000 \\ 00100000 \\ 00000000 \\ 00001000 \\ 00000000 \\ 00000010 \\ 00000000\end{matrix} ] \qquad \text{(formula 21)}$$

wherein,[Xt] consists of top field pixels only of 8×8 blocks.

Accordingly, by using the above formulae, the frame DCT coefficients [X] may be represented by IDCT coefficients [Xt] of the top fields by formula 22.

[Xt]=[I_{f}][x]=[I_{f}][T8^{T}][X]=[Q][X] (formula 22)

If Q of the formula 22 is converted into Q′ of formula 23, the IDCT coefficients of the top field may be obtained.

$$[ Xt ] = [ \begin{matrix}xt \\ xt \\ xt \\ xt\end{matrix} ] = [ {Q}^{′} ] [ X ] \qquad \text{(formula 23)}$$

wherein, [Q′] may be represented by formula 24.

$$[ {Q}^{′} ] = [ \begin{matrix}{t}_{00} {t}_{10} {t}_{20} {t}_{30} {t}_{40} {t}_{50} {t}_{60} {t}_{70} \\ {t}_{02} {t}_{12} {t}_{22} {t}_{43} {t}_{42} {t}_{52} {t}_{62} {t}_{72} \\ {t}_{04} {t}_{14} {t}_{24} {t}_{34} {t}_{44} {t}_{54} {t}_{64} {t}_{74} \\ {t}_{06} {t}_{16} {t}_{26} {t}_{36} {t}_{49} {t}_{56} {t}_{66} {t}_{76}\end{matrix} ] \qquad \text{(formula 24)}$$

In conclusion, the down-sampling method of the DCT conversion area is the result of IDCT after removing the high frequency components of the top field DCT coded coefficients in the horizontal direction.

First of all, similarly to the above formula 19, a 4×4 DCT matrix consisting of 4-point DCT basis is assumed to be [T4]. Then, the process that carrying out the down-sampling after removing the high frequency components is represented by formula 25.

$$[ \begin{matrix}y \\ y \\ y \\ y\end{matrix} ] = [ {P4}^{T} ] [ \begin{matrix}X \\ X \\ X \\ X \\ X \\ X \\ X \\ X\end{matrix} ] \qquad \text{(formula 25)}$$

wherein, [P4] is defined as following formula 26.

$$[ P4 ] = [ \begin{matrix}{T}_{4} \\ 0\end{matrix} ] / \sqrt{2} \qquad \text{(formula 26)}$$

Now, the macro blocks, that is, four 8×8 DCT blocks X1, X2,X3,X4 will be described in more detail.

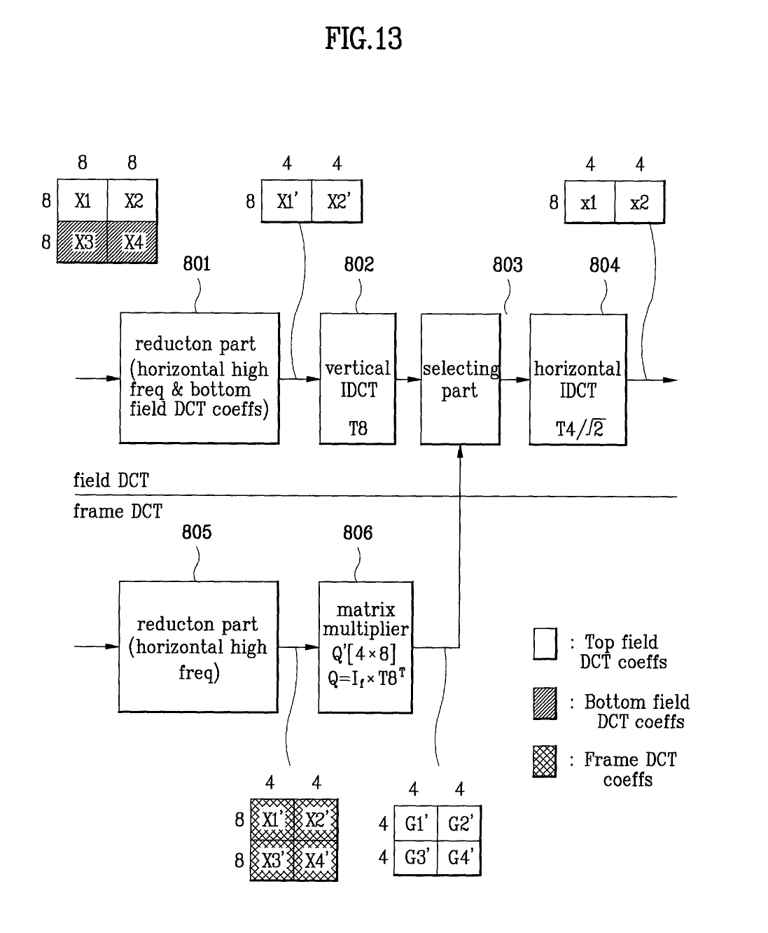

Referring to FIG. 13, if an input data is a field DCT coded macro block, the data is input to a first reduction part 801. The first reduction part 801 removes blocks (X3,X4) corresponding to a bottom field and removes the high frequency components in the horizontal direction for the remaining blocks. The blocks (X1′,X2′) are input to a horizontal IDCT part 804 via a vertical IDCT part 802 and a selection part 803, for carrying out 8×4 IDCT in the vertical/horizontal directions.

On the other hand, if the input data is the frame DCT coded MB block, the input data is input to a second reduction part 805.

The second reduction part 805 removes the high frequency components in horizontal direction and outputs to a matrix multiplier 806. The matrix multiplier 806 outputs blocks G1′,G2′,G3′,G4′ of the top field structure, which are down-sampled in vertical direction by using matrix [Q′] of formula 24, from the blocks x1′,x2′,x3′,x4′, of which the high frequency components in the horizontal direction are removed. The blocks are input to the horizontal IDCT part 804 via the selection part 803 and subject to 8×4 IDCT in the horizontal direction, thereby obtaining blocks x1,x2 of the final top field.

In case of an Intra-picture (I-picture), the result is directly stored in the memory 310 via the adaptive IDCT part 704. On the other hand, incase of a Predictive picture (P-picture) or Bidirectional picture (B-picture), the result is added to the data motion compensated by motion prediction and then stored in the memory 710.

Therefore, in the present invention, the full-resolution motion vectors are utilized rather than scaling down the motion vectors in the horizontal direction in order to increase the screen quality in case of the motion compensation.

In order to use the full-resolution motion vectors, up-sampling process is required for restoring a reduced reference picture in the memory 710 to an original resolution. Further, a down-sampling process is required for reducing the original resolution to ¼ resolution after the motion compensation.

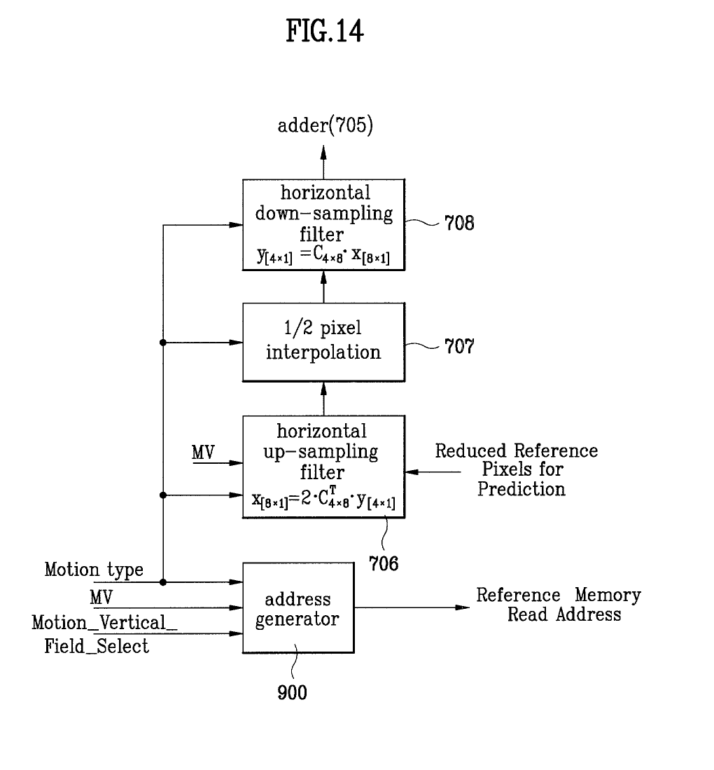

FIG. 14 is a block diagram showing motion compensation in case of a down-convergence.

As described above, the memory 710 stores pictures of the top fields. An address generating part 900 sends a read address to the reference memory 710 by using the motion vectors from the VLD part 702, motion-_type signals and motion_vertical_field_select signals, for reading reduced top field reference signals from the memory 710.

The data of the read address is read from the reference memory 710 and passes through the up-sampling part 706, the motion compensation part 707 and the down-sampling part 708 in sequence.

As shown in FIG. 14, the motion compensation part 707 is divided into the frame prediction and the field prediction according to motion_type.

In case of the motion compensation by using the field prediction, the up-sampling part 706 carries out the up-sampling in the horizontal direction for the selected fields according to motion_vertical_field_select signals. At this time, there is no bottom field, all the motion_vertical_field_select signals are controlled to indicate the top fields. The address generating part 900 provides only the reference blocks corresponding to the top fields to the horizontal up-sampling part 706 by sending a read address to the reference memory 710 by using the full-resolution motion vectors.

Therefore, the motion compensation part 707 obtains motion compensated blocks by half-pel prediction with relation to the blocks horizontally up-sampled in the up-sampling part 706. The down-sampling part 708 receives the motion compensated blocks and carries out the down-sampling in the horizontal direction to output to the macro block adder 705.

In the meantime, in case of the motion compensation by using the frame prediction, the address generating part 900 sends a read address to the reference memory 710 by using the full-resolution motion vectors. Then, the reference memory 710 reads reference blocks of the top fields only and outputs to the up-sampling part 706. At this time, the up-sampling part 706 carries out up-sampling with relation to the top fields only and the motion compensation part 707 obtains motion compensated blocks by the half-pel prediction with relation to the up-sampled blocks. Next, the down-sampling part 708 carries out the down-sampling for the input blocks of the motion compensated top fields in the horizontal direction to output to the macro block adder 705, wherein the processing time is reduced half since the processor for the bottom fields is not required any more.

The picture quality of the motion compensated picture depends on the characteristics of the up/down sampling parts 706,708. The up-sampling/down-sampling filter system employed in the present invention utilize matrices composed of DCT bases.

First of all, one-dimensional down-sampling is represented by formula 27 by using the above formula 25 and formula 26.

y_{[4×1]}=P₄^{T}·X_{[8×1]}=[T4^{T}0]/√·[T₈]·x_{[8×1]} (Formula 27)

x represents 8×1 pixels, y represents down-sampled 4×1 pixels, X represents DCT coded coefficient blocks for x, and T₈ represents 8×8 DCT basis matrix. Further,

$${P}_{4} [ \begin{matrix}{T}_{4} \\ 0\end{matrix} ] / \sqrt{2} ,$$

and T₄ represents 4×4 DCT basis matrix.

Therefore, the down-sampling conversion from pixel to pixel unit may be represented by following formula 28.

y_{[4×1]}=C_{4×8}·x_{[8×1]} (Formula 28)

wherein, C_{4×8}=C₄^{T}·T₈ is defined by 4×8-dimensional down-sampling matrices, and eight pixels are converted into four pixels.

On the other hand, the up-sampling system is formed of inverse-conversion of the above formulae for the down-sampling, wherein four pixels are converted into eight pixels. First of all, eight DCT coefficients are obtained by the above formula 27, which may be represented by formula 29 as follows.

$${X}_{[ 8 \times 1 ]} = [ \begin{matrix}{T}_{4} \\ 0\end{matrix} ] \cdot \sqrt{2} \cdot {y}_{4 \times 1} = {C}_{4} \cdot {y}_{4 \times 1} \cdot 2 \qquad \text{(formula 29)}$$

The 8-point IDCT result by using the above formula 29 may be obtained by formula 30 as follows.

x_{[8×1]}^{up}=T₈^{T}·X^{|}_{[8×1]} (Formula 30)

Finally, the above formula 29 and formula 30 may be represented by formula 31 as follows.

x_{[8×1]}^{up}=T₈^{|}·C₄·y_{4×1}·2=2·C_{4×8}^{|}·y_{4×1} (Formula 31)

The above formula 31 represents the up-sampling process of ½ resolution picture, which is stored in the memory 710, to an original picture.

The macro blocks are reproduced for the original resolution by carrying out the up-sampling in the horizontal/vertical directions by using the up-sampling matrices of the above formula 31 in the up-sampling part 706.

If the half-pel interpolation exists in the horizontal direction or full resolution motion vectors are not decreased below a multiple of 8, the up-sampling part 706 reads environmental blocks of 8×4 units in the horizontal direction from the memory 710. Then, as induced in the formula 31, the full-resolution blocks consisting of the top fields only are restored for the blocks in the horizontal direction by using the up-sampling matrices. The motion compensation part 707 carries out the half-pel interpolation for areas corresponding to the full-resolution motion vectors to obtain desired motion compensated blocks.

The blocks obtained as above are subject to the down-sampling process to be added to the 8×4 IDCT result in the MB adder 705.

By using the down-sampling of the above formula 28, macro blocks having a ½ size in the horizontal direction may be obtained. Thus obtained macro blocks are stored in the memory 710 again via the MB adder 705, wherein the top field blocks are added.

As shown in FIG. 4, the reduced-resolution pictures are displayed on the screen via the VDP 312 according to various display modes.

That is, the VDP 711 displays the reference pictures having the top fields only corresponding to the ¼ resolution of the original signal on the diplay device.

On the other hand, even though the present invention is described for the example of the IDCT process in which the down-sampling is carried out for the top fields only in the horizontal direction while removing the bottom fields, it is also possible to remove the top fields and carry out the IDCT for the bottom fields only by carrying out the down-sampling in the horizontal direction. This may be determined by a designer. Also, by carrying out the IDCT for the top fields without removing the high frequency components in the horizontal direction, 50% memory reduction effect may be obtained.

Further, the first and second preferred embodiment of the present invention are utilized for several interlaced scanning video signals of the high density grade, which were encoded to the high screen quality, on a single screen or the display of signals of high density grade of the high resolution by the low resolution screen of the standard definition grade, with 75% memory reduction effect of the existing video decoder of the high density grade. In particular, the present invention is advantageous in the application to the low cost MPEG-2 decoder chips which are applied to the digital TVs or system application fields of the digital picture meetings.

As an example, according to the present invention, 1920×1080 image bit streams of the high resolution and interlaced scanning high density grade of the MPEG2 MP@HL may be decoded and displayed on a 960×540 interlaced scanning screen device of the low resolution SD (standard definition) grade.

As described hereinabove, according to the apparatus for receiving digital motion pictures of the present invention, 75% memory reduction effect may be obtained by a video decoder having the down-converter for the interlaced scanning sequence of the HD grade and the SD grade screen of good picture quality may be obtained in various PIP (pictures in picture) or low resolution display devices.

Further, a plurality of video of the HD grade and the plurality kinds of various video of the SD grade may be displayed on a single screen by a memory for processing a single video of the HD grade, and the video signals of the HD grade may be watched by the low resolution display device without any burden of additional hardware.

In particular, the present invention may have a great effect in the high performance video decoder, to carry out multi-decoding essentially required in the application fields of the digital TVs or video images processing, and receive and process a plurality of videos in a single screen, and increase the technical competence in the digital TVs fields.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus for receiving digital motion pictures, comprising:
a video bit stream extracting means for separating and extracting a bit stream including video signals; and
a video display processor for carrying out down-conversion by converting the extracted video stream to a field DCT coded block if the video bit stream is an interlaced scanning sequence with a frame DCT coded block, while carrying out a down-conversion as it is if the video bit stream has a field DCT coded block, and storing the down-conversion result in a memory for motion compensation.

2. An apparatus for receiving digital motion pictures of claim 1, wherein the video display processor performs variable length decoding and interlacing of an input bit stream and performs 4×4 inverse discrete cosine transform IDCT after removing a DCT coefficient of a high frequency component in horizontal/vertical directions if the DCT coefficient is a field DCT type of an interlaced sequence, while performs a downsampling in a vertical direction in a converted field DCT domain after removing the DCT coefficient of the high frequency component in the horizontal direction and converting to a field DCT data if the DCT coefficient is a frame DCT type.

3. An apparatus for receiving digital motion pictures of claim 1, wherein, the video display processor performs up-sampling filtering in vertical/horizontal directions with relation to a data read from the memory before the motion compensation in case that full resolution motion vectors are utilized for the motion compensation, and performs down-sampling filtering in the vertical/horizontal directions after the motion compensation.

4. A video decoding device in which input video bit streams are restored into pixel values of an original screen by the steps of inverse quantization IQ after variable length decoding VLD, inverse discrete cosine conversion IDCT, and motion compensation MC, comprising:
a down-sampling IDCT part for carrying out 4×4 inverse discrete cosine transform IDCT after removing DCT coefficients of high frequency components in horizontal/vertical directions if the inverse quantized DCT coefficient are field DCT coded data, while performs down-sampling of a frame DCT coded data in vertical direction in a DCT domain after removing DCT coefficients of the high frequency components in horizontal direction to convert it to field DCT coded data if the inverse quantized DCT coefficients are the frame DCT coded data;
a memory for storing the IDCT data of an IDCT part or a result of adding the IDCT data to motion compensated data;
an up-sampling part for carrying out up-sampling of a reference picture which is read from a memory in horizontal/vertical directions;
a motion compensation part for carrying out motion compensation with relation to the picture which is up-sampled in horizontal/vertical directions in the up-sampling part by using motion vectors of a variable length decoded full resolution;
a down-sampling part for carrying out down-sampling of the motion-compensated data in the motion compensation part in horizontal/vertical directions and storing in the memory after adding to the IDCT data; and
a video display processor for reading the data stored in the memory according to a display mode to output to a display device.

5. A video decoding device of claim 4, wherein the IDCT part comprises:
a horizontal reduction part for removing the DCT coefficients of the high frequency components in horizontal direction if an input data is the frame DCT coded block of the interlaced sequence;
a frame/field converter for converting the frame DCT coded block, of which DCT coefficients of the high frequency components in the horizontal direction are removed, to the field DCT coded block;
a matrix multiplier for down-sampling the field DCT coded block in the vertical direction to output the IDCT coefficients of a field structure; and
a horizontal IDCT for carrying out IDCT in the horizontal direction with relation to the output data from the matrix multiplier.

6. A video decoding device of claim 4, wherein the frame/field converter converts two vertical blocks [x] having eight frame DCT coefficients to two field DCT coded blocks [Xtb] with relation to top and bottom fields by applying following matrix
$$[ Xtb ] = [ {T}_{f} ] [ {IT8}_{2} ] [ X ] = [ \begin{matrix}[ \begin{matrix}Xt \\ Xt \\ Xt \\ Xt \\ Xt \\ Xt \\ Xt \\ Xt\end{matrix} ] \\ [ \begin{matrix}Xb \\ Xb \\ Xb \\ Xb \\ Xb \\ Xb \\ Xb \\ Xb\end{matrix} ]\end{matrix} ]$$
$$wherein , \\ {T}_{f} = [ \begin{matrix}\begin{matrix}\vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}} & \vec{0}\end{matrix} \\ \begin{matrix}\vec{0} & \vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}}\end{matrix}\end{matrix} ] \\ [ {IT8}_{2} ] = [ \begin{matrix}{T8}^{T} & 0 \\ 0 & {T8}^{T}\end{matrix} ]$$
[T8] represent 8×8 DCT basis matrix consisting of 8-point DCT bases, IDCT with relation to two vertical blocks are represented by [IT8₂] matrix, and \vec{t}₁ represents i-th 8-point DCT basis vectors.

7. A video decoding device of claim 5, wherein the matrix multiplier outputs IDCT coefficients [ytb] of field units which are down-sampled in the horizontal/vertical direction by applying following matrix.
$$[ ytb ] = [ Q ] [ X ] = [ {IP4}_{2} ] [ {T}_{f} ] [ {IT8}_{2} ] [ X ] = [ \begin{matrix}yt \\ yt \\ yt \\ yt \\ yb \\ yb \\ yb \\ yb\end{matrix} ]$$
wherein,
$$[ {IP4}_{2} ] = [ \begin{matrix}{T4}^{T} & 0 & 0 & 0 \\ 0 & 0 & 0 & {T4}^{T}\end{matrix} ] / \sqrt{2}$$
is a down-sampling matrix of field DCT coded coefficients, and [T4] represents 4×4 DCT matrix consisting of 4-point DCT bases,
$${T}_{f} = [ \begin{matrix}\begin{matrix}\vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}} & \vec{0}\end{matrix} \\ \begin{matrix}\vec{0} & \vec{{t}_{0}} & \vec{0} & \vec{{t}_{1}} & \vec{0} & \vec{{t}_{2}} & \vec{0} & \vec{{t}_{3}} & \vec{0} & \vec{{t}_{4}} & \vec{0} & \vec{{t}_{5}} & \vec{0} & \vec{{t}_{6}} & \vec{0} & \vec{{t}_{7}}\end{matrix}\end{matrix} ] \\ [ {IT8}_{2} ] = [ \begin{matrix}{T8}^{′} & 0 \\ 0 & {T8}^{′}\end{matrix} ]$$
wherein, [T8] represents 8×8 DCT basis matrix consisting of 8-point DCT bases, IDCT for two vertical blocks is represented by [IT8₂] matrix, \vec{t}₁ represents i-th 8-point DCT basis vectors, and [X] represents two vertical blocks having eight frame DCT coefficients.

8. A video decoding device of claim 7, wherein the matrix [Q] of the matrix multiplier is 8×16 matrix which operates only for the DCT coefficients in the vertical direction.

9. A video decoding device of claim 4, wherein the up-sampling part selects fields proper for the motion vectors in case of the motion compensation, and carries out the up-sampling filtering in the horizontal/vertical directions for the respective fields after reading reference blocks corresponding to the selected fields from the memory.

10. A video decoding device of claim 4, wherein the motion compensation part forms motion compensated field blocks by half-pel interpolation with relation to the up-sampled blocks in case of the motion compensation using the field prediction, while forms motion compensated frame blocks by the half-pel interpolation after forming reference blocks of the frame units with the up-sampled blocks of the respective fields in case of the motion compensation using the frame prediction, so that the motion compensated frame blocks are separated per the respective fields.

11. A video decoding device of claim 4, wherein the down-sampling part converts eight pixels into four pixels by applying following 4×8-dimensional down-sampling matrix C_{4×8}.
C_{4×8}=C₄^{T}·T₈
wherein,
$${C}_{4} = [ \begin{matrix}{T}_{4} \\ 0\end{matrix} ] / \sqrt{2} C$$
and T₈ represents a matrix consisting of 8×8 DCT bases, and T₄ represents a matrix consisting of 4×4 DCT bases.

12. A video decoding device of claim 4, wherein the up-sampling part converts four pixels to eight pixels by applying following up-sampling matrix.
2·C_{4×8}^{T}

13. A video decoding device of claim 4, wherein the video display processor further includes a post-processing filter for amending the bottom fields before displaying the reference pictures having the field-based vertical structure on a screen.

14. An apparatus for receiving digital motion pictures, comprising:
a video bit stream extracting means for separating and extracting a bit stream including video signals; and
a video processor for carrying out down-conversion of a DCT coded block and a field DCT coded block to a picture of a pixel structure based on a top field to store in a memory for carrying out motion compensation, if the extracted video bit stream is an interlaced sequence.

15. An apparatus of claim 14, wherein the video display processor performs variable length decoding and inverse quantization for an input video bit stream and removes DCT coefficients of the bottom fields if the inverse-quantized DCT coefficients are the field DCT data of interlaced sequence, and a DCT coefficients of high frequency components of the top field, so as to carry out 8×4 inverse discrete cosine transform, wherein the video display processor removes the DCT coefficients of the high frequency components in the horizontal direction and extracts only the top fields to carry out the IDCT in case of the frame DCT data.

16. An apparatus of claim 14, wherein the video display processor carries out the up-sampling in the horizontal direction by reading the reference data of the top fields from the memory before the motion compensation in case of the motion compensation using full-resolution motion vectors, and the down-sampling in the horizontal direction after the motion compensation.

17. A video decoding device in which input video bit streams are restored into pixel values of an original screen by the steps of inverse quantization IQ after variable length decoding VLD, inverse discrete cosine conversion IDCT, and motion compensation MC, comprising:
an IDCT part for carrying out 8×4 IDCT after removing DCT coefficients of bottom fields and DCT coefficients of high frequency components of top fields if the inverse-quantized DCT coefficients are field DCT data of interlaced sequence, while removing DCT coefficients of high frequency components in horizontal direction and extracting top fields only if the inverse-quantized DCT coefficients are frame DCT data;
a memory for storing the IDCT data of an IDCT part or a result of adding the IDCT data to motion compensated data;
an up-sampling part for carrying out up-sampling of a reference picture which is read from the memory in horizontal direction;
a motion compensation part for carrying out motion compensation with relation to the picture which is up-sampled in horizontal direction in the up-sampling part by using motion vectors of VLD full-resolution;
a down-sampling part for carrying out down-sampling for the data of which motion is compensated in the motion compensation part in horizontal direction and storing in the memory after adding to the IDCT data; and
a video display processor for reading the data stored in the memory according to a display mode to output to a display device.

18. A video decoding device of claim 17, wherein the IDCT part comprises:
a horizontal reduction part for removing the DCT coefficients of the high frequency components in horizontal direction if an input data is a frame DCT coded block of the interlaced sequence;
a converter for converting the frame DCT coded block, of which DCT coefficients of the high frequency components are reduced in the horizontal direction, to the field DCT coded block so as to output IDCT coefficients of the top fields only; and
a horizontal IDCT for carrying out IDCT in the horizontal direction with relation to the output data from the converter.

19. A video decoding device of claim 18, wherein the converter converts the vertical blocks [x] having eight frame DCT coefficients to IDCT coefficients [Xt] of the top fields by applying following matrix.
$$[ Xt ] = [ \begin{matrix}xt \\ xt \\ xt \\ xt\end{matrix} ] = [ {Q}^{′} ] [ X ]$$
$$wherein , [ {Q}^{′} ] = [ \begin{matrix}{t}_{00} {t}_{10} {t}_{20} {t}_{30} {t}_{40} {t}_{50} {t}_{60} {t}_{70} \\ {t}_{02} {t}_{12} {t}_{22} {t}_{32} {t}_{42} {t}_{52} {t}_{62} {t}_{72} \\ {t}_{04} {t}_{14} {t}_{24} {t}_{34} {t}_{44} {t}_{54} {t}_{64} {t}_{74} \\ {t}_{06} {t}_{16} {t}_{26} {t}_{36} {t}_{46} {t}_{56} {t}_{66} {t}_{76}\end{matrix} ]$$

20. A video decoding device of claim 17, wherein the up-sampling part selects the top fields with relation to the motion vectors of which reference fields are the bottom fields when performing the motion compensation and carries out the up-sampling filtering in the horizontal direction for the selected top field reference signals in the horizontal direction.

21. A video decoding device of claim 17, wherein the motion compensation part forms motion compensated field blocks by half-pel interpolation using the full-resolution motion vectors with relation to the up-sampled blocks in case of the motion compensation using the field prediction, while forms motion compensated frame blocks by the half-pel interpolation using the full-resolution motion vectors with relation to the up-sampled blocks of the top fields in case of the motion compensation using the frame prediction.

22. A video decoding device of claim 17, wherein the down-sampling part converts eight pixels to four pixels by applying 4×8-dimensional down-sampling matrix C_{4×8}.
C_{4×8}=P₄^{T}·T₈
wherein,
$${P}_{4} = [ \begin{matrix}{T}_{4} \\ 0\end{matrix} ] / \sqrt{2} C$$
and T₈ represents a matrix consisting of 8×8 DCT bases, and T₄ represents a matrix consisting of 4×4 DCT bases.

23. A video decoding device of claim 17, wherein the up-sampling part converts four pixels to eight pixels by applying following up-sampling matrix.
2·C_{4×8}^{T}
